(19) United States
(12) Patent Application Publication
(10) Pub. No.: US 2004/0058111 A1
(43) Pub. Date: Mar. 25, 2004

(54) Compounded nylon 6, nylon 12 material for air brake systems

(75) Inventors: Iani Manas-Zloczower, Orange, OH (US); Roger C. Schley, Parma, OH (US); Craig A. Danko, Lewis Center, OH (US); Roger J. Lewicki, Brecksville, OH (US); Randall W. Thompson, Stow, OH (US)

Correspondence Address: Christopher B. Fagan, Esq., Fay, Sharpe, Fagan, Minnich & McKee, LLP, 7th Floor, 1100 Superior Avenue, Cleveland, OH, 44114-2518, US

(73) Assignee: Saint-Gobain Performance Plastics Corp.

(21) Appl. No.: 10/252,653

(22) Filed: Sep. 23, 2002

(51) Int. Cl. B32B 1/08

(52) U.S. Cl. 428/36.91; 138/125

(57) ABSTRACT

A compounded alloy of nylon 6 and nylon 12 serves as a layer of a hose suited to use in airbrake materials. The alloy is resistant to degradation by zinc chloride and moisture and thus may be used as a peripheral layer of the hose in place of a conventional protective layer comprising a pure polyamide, such as nylon 11 or 12. Alternatively, the alloy may be used as a tie layer for rendering a peripheral layer comprising nylon 12 compatible with a layer of nylon 6, allowing the less expensive nylon 6 material to comprise the bulk of the hose thickness. The alloy includes a compatibilizer, such as a maleic anhydride grafted polyethylene in sufficient amount to render the alloy compatible with adjacent layers, thus avoiding the need for an intermediate layer of an adhesive. One or more of plasticizers and impact modifiers are preferably also present in the alloy to provide improved strength and flexural characteristics.

### BACKGROUND OF THE INVENTION

1. Field of the Invention

The invention relates to a composite material suited to use in forming hoses for use in air brake systems and other applications where hoses are pressurized with a gas or hydraulic fluid. In particular, it relates to an alloy of nylon 6 and nylon 12, and will be described with particular reference thereto.

2. Discussion of the Art

Air brake systems are widely used in heavy duty vehicles, such as tractor trailers and the like. In such systems, the brake system is connected with a source of compressed air by a flexible tube or hose, which kept pressurized at about 8.4-10.5 kg/cm² (120-150 psi). Tubing formed from a polyamide, such as nylon, is disclosed in Brumbach, U.S. Pat. No. 3,062,241, and is widely used for this purpose. Typically, air brake hoses are formed of a multi-layer construction, with inner and outer layers being formed of a material which resistant to the surrounding environment. In particular, the inner and outer layers are formed from a material which is not sensitive to stress cracking by zinc chloride, such as nylon 11 (polyundecanolactam) or nylon 12 (polydodecanolactam). The inner and outer layers are separated by an intermediate layer of woven or braided material, such as a polyester fiber, which acts as a reinforcement.

Nylon 6 (polycaprolactam) has been considered to be unsuited to use in air brake hoses due to its susceptibility to stress cracking if it comes into contact with zinc chloride. Zinc chloride resistance of hoses is particularly important in areas where road salt is used to melt ice and snow and in marine environments. Hose connectors are frequently zinc plated and, when contacted with sodium chloride from salt spray and the like, form zinc chloride. The zinc chloride attacks nylon 6, causing it to break down. Additionally, nylon 6 tends to become brittle at very low temperatures, typically at about −40° C.

Nylon 11 and nylon 12 are not, however, without some concerns. They are both unsuited to use at temperatures below about −40° C. or at high temperatures, i.e., higher than about 95° C. Additionally, the cost of nylon 11 and nylon 12 is significantly higher than nylon 6 and there are a limited number of suppliers from which these materials can be obtained.

It is considered desirable to form a hose having the zinc chloride resistant properties of nylon 11 or 12 while providing the cost and structural advantages of nylon 6. However, nylon 6 is not compatible with nylon 11 and nylon 12. This means that adjacent layers of nylon 6 and nylon 11 or nylon 12 do not form a cohesive laminate structure when coextruded.

In U.S. Pat. No. 5,076,329 to Brunnhofer, a five-layer fuel line is proposed which is composed of a thick outer layer formed of Nylon 11 or Nylon 12, a thick intermediate layer of Nylon 6, and a thin intermediate bonding layer between and bonded to the intermediate and outer layers formed of a polyethylene or a polypropylene. On the interior of the tube is an inner layer of Nylon 6 with a thin intermediate solvent-blocking layer formed of an ethylene-vinyl alcohol copolymer transposed between.

In U.S. Pat. No. 5,038,833 to Brunnhofer, a three-layer fuel line is proposed in which a tube is formed having a co-extruded outer wall of a polyamide, such as Nylon 11 or Nylon 12, an intermediate alcohol barrier wall formed from an ethylene-vinyl alcohol copolymer, and an inner water-blocking wall formed from Nylon 11 or Nylon 12. In U.S. Pat. No. 5,219,003 to Kerschbaumer, a fuel line is proposed in which an intermediate solvent barrier layer is formed of unmodified Nylon 6,6 (polyhexamethylene adipamide) either separately or in combination with blends of polyamide elastomers. The internal layer is also composed of polyamides; preferably modified or unmodified Nylon 6 while the outer layer is composed of either Nylon 6 or Nylon 12.

For pressurized gas hoses, such as air brake hoses, the structural and chemical requirements are generally different from those for fluid lines. Hoses with intermediate layers which are not compatible with the adjacent nylon layers or which use an adhesive layer to provide bonding between incompatible layers tend to lack the desired mechanical properties and lamination strength to meet the rigorous standards for air brake hoses.

Nylon 6,12 materials have been formed by copolymerization of nylon 6 and nylon 12 monomer units. However, commercially available nylon 6,12 materials of this type are unsuited for use in air brake hoses due to their high stiffness. Additionally, the processing systems for such copolymerization reactions are unsuited to forming small quantities of the material.

The present invention provides a new and improved airbrake hose material which overcomes the above-referenced problems and others.

### SUMMARY OF THE INVENTION

In accordance with one aspect of the present invention, a hose suitable for use in pressurized fluid systems is provided. The hose includes a first layer which includes an alloy of a first polymer which is derived from caprolactam, and a second polymer derived from at least one of undecanolactam and dodecanolactam. The hose includes at least one of a second layer and a third layer. The second layer, where present, is bonded directly to the first layer and includes a third polymer which is derived from caprolactam. The third layer, where present, is bonded directly to the first layer. The third layer includes a fourth polymer derived from the at least one of undecanolactam and dodecanolactam. The first polymer and third polymer may be nylon 6 or nylon 6,6 and the second polymer and fourth polymer may be nylon 12 or nylon 11.

In accordance with another aspect of the invention, a formulation suitable for forming a layer of a hose is provided. The formulation includes 30-40% of a polyamide derived from caprolactam, 20-35% of nylon 11 and/or nylon 12, 5-20% of a plasticizer other than caprolactam, 0-10% of caprolactam; 5-25% of a maleic anhydride grafted polyalkylene, and 0-20% of an impact modifier other than the maleic anhydride grafted polyalkylene.

In accordance with another aspect of the invention, a method of forming a multi-layer structure is provided. The method includes coextruding a first layer and at least one of a second layer and a third layer. The first layer bonds to the at least one of the second layer and the third layer as the layers are coextruded. The first layer includes an alloy of nylon 6 and nylon 12 formed by mixing a nylon 6 polymer with a nylon 12 polymer. The second layer, where present, includes nylon 6. The third layer, where present, includes nylon 12.

In accordance with another aspect of the invention, a multi-layer structure is provided. The structure includes a first layer, which includes nylon 12, a second layer which includes a mixture of a nylon 6 polymer and a nylon 12 polymer. The second layer is adjacent to the first layer. Optionally, a third layer, which includes a mixture of a nylon 6 polymer and a nylon 12 polymer, is spaced from the second layer by at least a fourth layer, the fourth layer including nylon 6.

In accordance with another aspect of the invention, a hose is provided. The hose includes an inner peripheral surface and an outer peripheral surface. The outer peripheral surface is radially outwardly spaced from the inner peripheral surface. A layer which defines at least one of the inner and outer peripheral surfaces includes a generally homogeneous mixture of a nylon 6 polymer and a nylon 12 polymer. The nylon 6 polymer and nylon 12 polymer are held together by maleic anhydride residues of a maleic anhydride modified polymer.

An advantage of at least one embodiment of the present invention is that it enables an air brake material hose to incorporate nylon 6 as an intermediate layer.

Another advantage of at least one embodiment of the present invention is the provision of an air brake hose with improved mechanical properties and laminate strength.

Another advantage of at least one embodiment of the present invention is that a nylon 6, nylon 12 material suited to use as a layer of an air brake hose is formed without the need for copolymerization of nylon 6 and nylon 12 monomers.

Another advantage of at least one embodiment of the present invention is that a process for forming nylon 6,12 material is provided which is suited to forming the material in smaller quantities than conventional copolymerization processes, allowing compositions to be individually tailored to specific applications.

Another advantage of at least one embodiment of the present invention is that it enables a hose to be formed in which all polyamide layers are replaced with a compounded nylon 6, nylon 12 material.

Still further advantages of the present invention will be readily apparent to those skilled in the art, upon a reading of the following disclosure and a review of the accompanying drawings.

### BRIEF DESCRIPTION OF THE DRAWINGS

FIG. 1 is a perspective view of an air brake hose in partial section, in accordance with the present invention;

FIG. 2 is a cross sectional view of a second embodiment of a hose, in accordance with the present invention;

FIG. 3 is a cross sectional view of a third embodiment of a hose in accordance with the present invention;

FIG. 4 is a cross sectional view of a fourth embodiment of a hose in accordance with the present invention;

FIG. 5 is a cross sectional view of a fifth embodiment of a hose in accordance with the present invention;

FIG. 6 is a cross sectional view of a sixth embodiment of a hose in accordance with the present invention; and

FIG. 7 is a cross sectional view of a seventh embodiment of a hose in accordance with the present invention; and

FIG. 8 is a multi-layer film according to the present invention.

### DETAILED DESCRIPTION OF THE PREFERRED EMBODIMENT

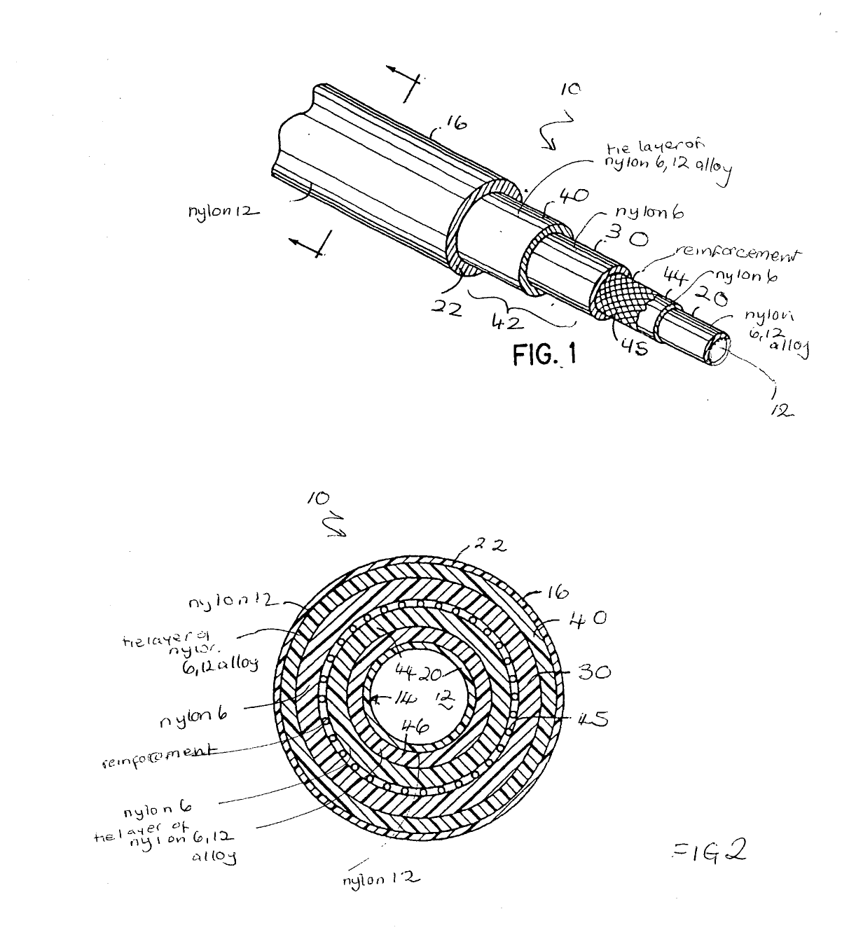

FIG. 1 illustrates a multi-layer structure, such as a hose or tube 10. The hose is suited to use in systems where the hose is pressurized with air, such as an air brake system for a vehicle, or in a tool which is operated by pressurized air. While particular reference is made to pneumatic systems employing pressurized gases, such as air, as the hose pressurizing medium, it is also contemplated that the hose be used with hydraulic pressurization (e.g., water or oil) or other liquid pressurizing media. The hose may also be used in systems where the fluid to be transferred is at or close to atmospheric pressure and in vacuum systems.

When used in an air brake system, the hose 10 is used for connecting a source of applied pressure, such as a compressor (not shown), with a braking system for the vehicle (not shown), and optionally with a reservoir for pressurized gas between the compressor and brake system. The hose is maintained under a positive pressure of about 8-12 kg/cm² for extended periods.

The hose 10 is of a laminate construction, one or more layers of the hose being formed of a compounded alloy nylon 6 and nylon 12 alloy (referred to herein as a nylon 6,12 alloy), which is described in further detail below. Alloys, in this regard, refer to immiscible polymer blends having a modified interface or morphology. The nylon 6,12 alloy has good zinc chloride and moisture resistance properties and flexibility and yet is compatible with nylon 6. As a result, layers of nylon 6 and the nylon 6,12 alloy can be coextruded as directly adjacent layers, having laminate strength, without the need for any adhesive between the two layers or other bonding medium.

While the application is described with particular reference to an alloy of nylon 6 and nylon 12, it is to be appreciated that the nylon 12 in the alloy could be replaced, in whole or in part, with another polyamide which exhibits the desired zinc chloride and/or moisture resistance properties, such as nylon 11 or a combination of two, or more such polyamides, such as a combination of nylon 11 and nylon 12 polymers or a nylon 11,12 copolymer. Where nylon 11 replaces nylon 12 in the alloy, the alloy is suited to coextrusion with a nylon 11 based adjacent layer. Where both nylon 11 and nylon 12 are used in the alloy layer, the alloy layer bonds to either a nylon 11 or a nylon 12 adjacent layer during coextrusion. However, the interlaminar strength may not be as strong as when the alloy employs simply the corresponding polyamide in the alloy (i.e., a nylon 6,12 alloy for bonding to a nylon 12 layer and a nylon 6,11 alloy for bonding to a nylon 11 layer).

It is also to be appreciated that nylon 6 in the alloy layer may be replaced in whole or in part by another polyamide derived from caprolactam, such as nylon 6,6 (a polymer of caprolactam and adipic acid), nylon 4,6 (a polymer of tetramethylenediamine-co-adipic acid and caprolactam), and the like.

The alloy can thus be described in general terms as an A,B alloy, where A comprises a first polyamide, preferably selected from the group consisting of nylon 12, nylon 11, and combinations thereof, and B comprises a second polyamide, different from the first polyamide, preferably selected from the group consisting of nylon 6, nylon 6,6, nylon 4,6, other caprolactam-based polyamides, and combinations thereof. The A,B alloy is compatible for coextrusion with a layer comprising A and/or a layer comprising B, to form a multi-layer structure, such as a hose.

For air brake applications, it is preferred that nylon 6 is not directly exposed to the environment to avoid zinc chloride degradation. It is therefore desirable to have an outer layer formed from a zinc chloride resistant material, such as the nylon 6,12 alloy, to space the nylon 6 from the surrounding environment. Or, the nylon 6,12 alloy may be used on its own, without any other polyamide layers. In yet another embodiment, the nylon 6,12 alloy may be used as a tie layer, i.e., as a thin layer, which is compatible with both a nylon 6 layer and a zinc chloride resistant layer, such as a layer of nylon 12. If a nylon 6,11 alloy is used, the alloy is suited to use as a tie layer between a nylon 6 and a nylon 11 layer.

While for convenience, layers of the hose 10 are described in general terms as “nylon 6” or “nylon 12”, or the like, it is to be appreciated that the layers frequently also contain a variety of other ingredients, such as plasticizers, impact modifiers, flexibilizers, and the like, as will be described in greater detail below. It is also contemplated that other polyamides be incorporated into the layers, provided these do not have a significant deleterious impact on the properties of the material or the compatibility of the material with the adjacent layer(s).

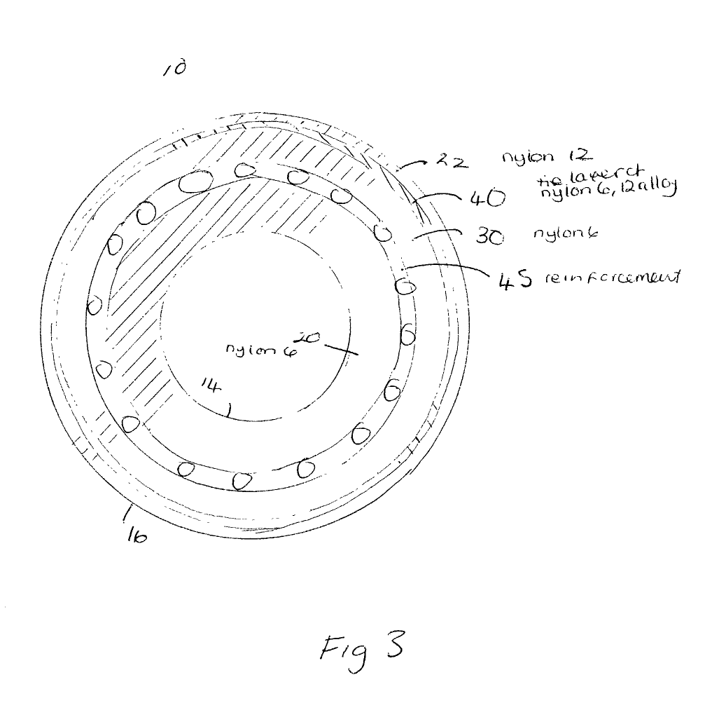

The hose 10 defines a hollow interior 12, which receives the pressurized air or other pressurized medium therein. As shown in FIG. 2, which shows a slightly modified hose 10, an inner peripheral surface 14 of the hose is in contact with the air. An outer peripheral surface 16 of the hose is in contact with the exterior environment, and is thus subject to being contacted by moisture and air and waterborne contaminants, such as zinc chloride. The hose 10 includes an inner peripheral layer 20, which defines the inner peripheral surface 14, and an outer peripheral layer 22, spaced radially outward of the inner layer 20, which defines the outer surface 16. Although layers 16 and 20 are intended to be used as peripheral (i.e., outermost and innermost) layers, it is to be appreciated that additional layers of material (not shown) optionally space the outer surface 16 from the environment or the inner surface 14 from the pressurized medium.

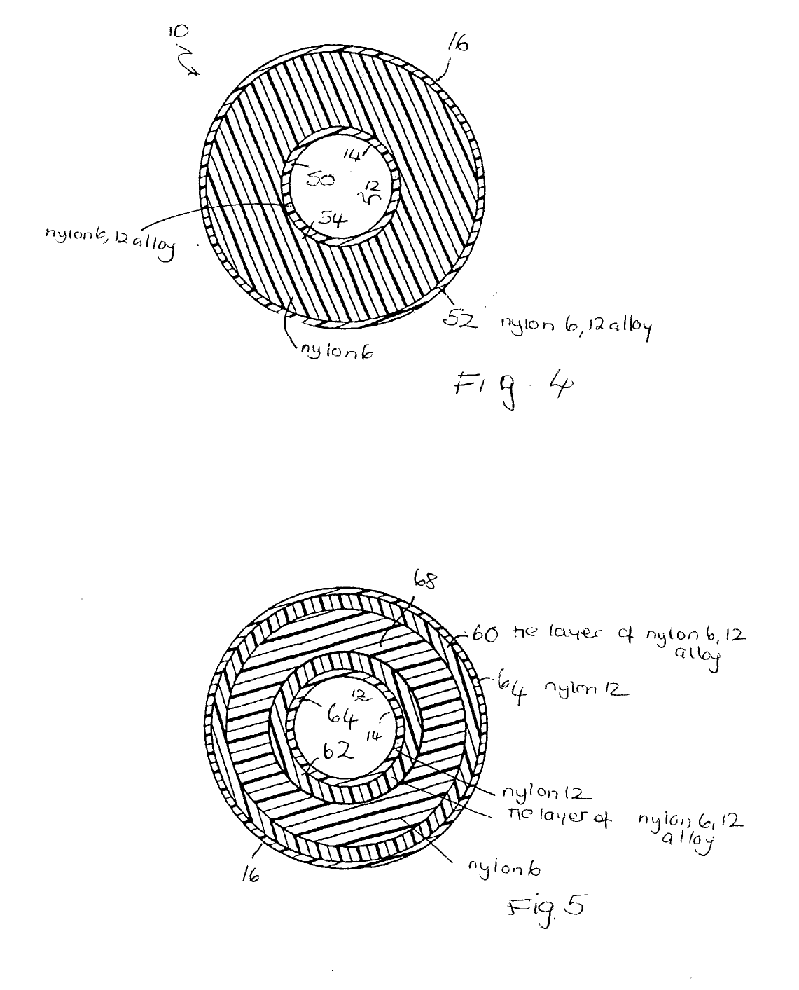

The outer peripheral layer 22 of FIGS. 1 and 2 is formed from a material which is resistant to zinc-chloride degradation, such as nylon 12. In alternative embodiments (see, e.g., FIG. 4), the nylon 6,12 alloy of the present invention acts as the outer layer 22. The layer 22 is of sufficient thickness to provide isolation of radially inward layers of the hose from the automotive environment, such as moisture and zinc chloride. Where zinc chloride degradation is of particular concern, or where automotive specifications require use of nylon 12 or other single polyamide, nylon 12 is preferred as the outer layer 22. It is desirable, due to the cost of nylon 12 (and, to a lesser extent, the nylon 6,12 alloy) relative to other polyamides, such as nylon 6, to have the outer layer 22 as thin as possible, while ensuring zinc chloride protection for the useful lifetime of the hose 10. Accordingly, layer 22 is preferably about 0.1-0.6 mm, more preferably, about 0.25-0.50 mm in thickness.

In the embodiments of FIGS. 1 and 2, an interior layer 30 of a polyamide, which need not possess zinc chloride and moisture resistance, such as nylon 6, is spaced radially inward of the outer layer 22. Where the outer layer is formed from nylon 12, a tie layer 40 of the nylon 6,12 alloy is interposed between the nylon 6 and nylon 12 layers 30, 22 to render them compatible for coextrusion. The tie layer 40 is generally thinner than either of the two adjacent layers, for example 0.05-0.15 mm in thickness, although greater thicknesses are also contemplated. The layers 22, 30 and 40 (where present) form a jacket 42 of the hose 10. The total thickness of the jacket 42 is preferably about 0.8-1.2 mm.

If the outer layer is formed from the nylon 6,12 alloy, as is the case in the embodiment of FIG. 4, the two layers 22, 30, may be adjacent (i.e., without intermediate layers between them), since the nylon 6,12 alloy is compatible with nylon 6 and may be coextruded therewith. No other intermediate layer, such as an adhesive layer, is necessary.

The inner layer 20 is shown in FIG. 1 as comprising a layer of the nylon 6,12 alloy. Layer 20, in this embodiment, is preferably about 0.1-0.5 mm, more preferably, about 0.25 mm in thickness. An interior layer 44 of a material compatible for coextrusion with the nylon 6,12 alloy layer is spaced radially outward of the inner layer 20. For example, layer 44 may be a similar nylon 6 material to that employed for layer 30. Layer 44 is preferably compatible with the innermost layer 30 of the jacket so that the two layers 44, 30 are compatible for coextrusion. In the preferred embodiment, layers 44 and 30 are preferably nylon 6. A layer 45 of a reinforcing material, such as polyester fiber, is embedded at the interface of the adjoining layers 44, 30.

Layer 44 is preferably about 0.5 to 0.9 mm in thickness, more preferably, about 0.6 mm in thickness. The layer 30 is preferably about 0.7 to 1.1 mm in thickness, more preferably, about 0.9 mm. Layers 30 and 44 provide the primary structural support for the tubing. Therefore, their thickness is determined by application requirements. In total, the polyamide layers 22, 40, 30, 44, 20 of the hose are preferably about 0.25-0.5 mm.

Alternatively, as shown in FIG. 2, the inner layer 20 is formed from nylon 12, with a tie layer 46 of the nylon 6,12 alloy interposed between the nylon 12 and nylon 6 layers 20, 44 and entirely or substantially coextensive therewith to permit coextrusion of the otherwise incompatible nylon 6 and nylon 12 layers. Layer 46, in this embodiment, is preferably of similar thickness to tie layer 40 of FIGS. 1 and 2, e.g., about 0.0025-0.005 mm in thickness. In this embodiment, layer 20 is preferably as thin as possible to allow cost savings while maintaining the desired zinc chloride and/or moisture protection. For example, layer 20, in this embodiment, is preferably about 0.25 mm in thickness.

The nylon 6,12 alloy is formed by compounding nylon 12 and nylon 6 polyamides with a compatibilizer. The compatibilizer serves to link the nylon 6 and nylon 12 polymers together. Preferably, the compatibilizer chemically bonds to both nylon 6 and nylon 12 polymers. This provides a material with the chemical, strength, and flexural properties to make it suitable for use as a tie layer 40, 46 or a zinc chloride resistant outer layer 16, 20 of the hose 10. A plasticizer is preferably incorporated into the layer to increase the flexibility of the structure. The formulation for the layer may also include impact modifiers, heat and light stabilizers, and the like.

Unlike copolymerized nylon 6,12, which is formed from monomer units of nylon 6 and nylon 12, which are copolymerized together, the present alloy is preferably formed from separately copolymerized nylon 6 and nylon 12 polymers. Nylon 6 is the condensation polymerization of caprolactam, while nylon 12 is the condensation product of dodecanolactam. The number average molecular weight is preferably at least about 5.000 for both the nylon 6 and nylon 12 polymers, more preferably, at least 10,000, and most preferably, in the range of about 10,000 to about 100,000. While it is anticipated for convenience that the polyamides used are 100% nylon 6 and 100% nylon 12, respectively, it is also contemplated that a portion of one and/or other of the polyamides be replaced with a nylon 6,12 copolymer. It will be readily appreciated that commercially available nylon 6 and nylon 12 polymers may contain an amount of the residual monomer (caprolactam or dodecanolactam), which is not deleterious.

The nylon 6,12 alloy used for layers 20, 40, and 46 preferably has the following characteristics:

Ambient flex modulus: 2800-7000 kg/cm² (40,000-100,000 psi), preferably about 3500 kg/cm² (50,000 psi) (as measured by ASTM Standard ASTM D-790).

Elastic modulus @ 110° C. (230° F.): 700-1750 kg/cm² (10,000-25,000 psi), preferably about 1400 kg/cm² (20,000 psi) (as measured by ASTM Standard ASTM D-638).

Yield Strength @ 110° C. (230° F.): 70-140 kg/cm² (1000-2000 psi), preferably about 105 kg/cm² (1500 psi) (as measured by ASTM Standard ASTM D-638).

Notched Izod Impact Strength @ −40° C.: about 38 joules/meter (about 0.7 ft-lbs/in), or greater, preferably, about 86 joules/meter (about 1.6 ft-lbs/in) (as measured by ASTM Standard D-256).

The nylon 6,12 alloy layers 20, 40, and 46 preferably comprise about 50-90%, more preferably, about 50-80%, and most preferably, about 65-75% polyamide in the ratio of from about 3:1 nylon 6: nylon 12 to about 1:3 nylon 6: nylon 12, more preferably from about 2:1 to 1:2 nylon 6: nylon 12, and most preferably, about 1.2:1 nylon 6: nylon 12. If the ratio of nylon 6: nylon 12 is significantly lower than 1:3 or higher than 3:1, the layer may not be sufficiently compatible with adjacent nylon 6 or nylon 12 layers to coextrude the layers to form a hose having the desired laminar strength for use with air brakes. Advantageously, to reduce material costs, the content of nylon 6 is preferably slightly higher than that of nylon 12.

A suitable formulation for forming the nylon 6,12 alloy thus preferably includes about 10-50%, more preferably, 25-45%, most preferably, 30-40% by weight of nylon 6 base resin and 10-50%, more preferably, 15-40%, most preferably, 25-35% by weight of nylon 12 base resin. The nylon 6 and nylon 12 resins are both generally solids at room temperature. When used as a structural layer rather than simply as a tie layer, the nylon 6 content is preferably below about 40% as otherwise, the stiffness of the resulting hose may be too high for air brake applications.

Nylon 6 resin suited to the present process is commercially available from BASF AG, Geismar, La., USA under the tradename Ultramid™ B35. Nylon 12 resin is obtainable from ATOFINA, USA, as Rislan™ AESNO P40 or AESNO P401 TL. The polyamide resins are preferably in the form of pellets, although other comminuted particles are also contemplated.

The formulation also includes a compatibilizer, which, as discussed above, renders the nylon 6 and nylon 12 resins compatible, by coupling the polymers together, for example, by forming a chemical linkage between the polymers. Suitable compatibilizers include polyolefins modified with an α,β-unsaturated carboxylic acid, an alicyclic carboxylic acid, or derivatives thereof, such as acrylic acid, methacrylic acid, maleic acid, fumaric acid, itaconic acid, endocyclo(2,2,1)-5-heptene-2,3-carboxylic acid, and cis-4-cyclohexene-1,2-carboxylic acid and anhydrides, esters, amides, and imides thereof.

Preferred compatibilizers are maleic anhydride modified polymers, such as maleic anhydride grafted polyolefins. Preferred olefins are ethylene and propylene, or combinations thereof, ethylene being particularly preferred. These polymers have a polyolefin backbone to which maleic anhydride residues are attached in a random fashion. The modified polypropylenes generally contain about 0.5% to about 10% of maleic acid or maleic anhydride, based on the total weight of the modified polymer. Preferably, the modified polymer is about 1% weight percent maleic anhydride, or less, i.e., only a small percentage of the olefin mer units are modified with the maleic anhydride in this way. A particularly preferred compatibilizer is maleic anhydride grafted polyethylene (MAGPE), which can be obtained from E. I. DuPont under the tradename Fusabond™ MN-493D Other suitable compatibilizers include acrylic acid modified polymers, such as acrylic acid modified polyolefins. The compatibilizer is preferably present at about 5-30% by weight of the formulation, more preferably, from about 10-20%, more preferably, about 10-18%, and most preferably, about 13% by weight of the formulation.

The maleic anhydride modified polymer or other suitable compatibilizer should be in the molten state to initiate the covalent bonds necessary for strong adhesion between the polyamides. Adhering to cold substrates using this so-called adhesive thermoplastic elastomer is generally unsuccessful. Little or no covalent bonds will form at the interface and the adhesion is therefore generally inadequate.

The formulation also preferably includes one or more of plasticizers and impact modifiers. The plasticizer serves to render the layer more flexible and so that it retains its flexibility under use conditions particularly when subject to low temperatures. The plasticizer is generally a liquid at room temperature. Suitable plasticizers are those which are stable at the processing temperatures of the formulation (typically at about 220° C.) and include alkyl aryl sulfonamides, such as butyl benzene sulfonamide. This plasticizer is available from Unitex under the tradename Uniplex™ 214. Another plasticizer is residual nylon 6 monomer (caprolactam). This material is naturally present in certain grades of nylon 6 at a level of about 2%, or less. The plasticizer is preferably present in the formulation at about 0-20%, more preferably, at about 7-10% by weight of the formulation. A combination of plasticizers, such as a combination of about 8% butyl benzene sulfonamide and about 1%, or less residual nylon 6 monomer, is optionally used.

Suitable impact modifiers include maleic anhydride-grafted polyolefin rubbers comprising an ethylene/propylene or ethylene/butene copolymer rubber and about 0.5% to about 10% of a diene, preferably about 2% to about 6%, such as maleic anhydride grafted ethylene/propylene/diene elastomers (MAGEPDE). The elastomer is preferably about 30% to about 70%, preferably about 40% to about 60%, ethylene, and about 0.4-2% grafted maleic anhydride. The ratio of ethylene/propylene is preferably about 75/25). The diene may be butadiene; 1,4-hexadiene; 1,5-hexadiene, ethylidenenorbornene, or the like. Suitable maleic anhydride grafted ethylene/propylene/non-conjugated diene elastomers are commercially available from Crompton Corp. under the tradename Royaltuf™ 498. The impact modifier is preferably present at a concentration of 0-20%, more preferably, 10-15%, and most preferably, about 13%.

Such maleic anhydride grafted ethylene/propylene/non-conjugated diene elastomers are colored and render the hose opaque. Where a translucent material is desired, the impact modifier is optionally eliminated. It should be noted that the MAGPE in the formulation serves a dual role in that it also serves as an impact modifier as well as a compatibilizer. Thus, where MAGPE is used as a compatibilizer, the presence of an additional impact modifier, such as MAGEPDE, is not essential. In such cases, the concentration of compatibilizer, plasticizer, and/or resin in the formulation is preferably increased slightly to make up for the weight of impact modifier.

The formulation may also contain suitable heat and light stabilizers, such as hindered amine light stabilizers, at from about 0.5 to 1.0 weight %. The nylon 12 base resin Rislan™ AESNO P401 TL already contains heat and light stabilizers and if this material is employed, additional heat and light stabilizers need not be added.

A preferred Nylon 6,12 alloy formulation includes:

Nylon 6 base resin: 30-40% by weight for an opaque formulation, 35-45% for a translucent formulation;

Nylon 12 base resin: 20-35% by weight for an opaque formulation, 25-40% for a translucent formulation;

Maleic anhydride grafted polyethylene (MAGPE): 0-20% by weight, preferably, about 13% for an opaque formulation, about 17% for a translucent formulation;

Plasticizer (butyl benzene sulfonamide): 0-20% by weight, preferably, about 8% for an opaque formulation, about 10% for a translucent formulation;

Residual nylon monomer: 0-10% by weight;

Maleic anhydride grafted ethylene/propylene/non-conjugated diene elastomer (MAGEPDE): 0-20% by weight, preferably about 13% for an opaque formulation, about 0% for a translucent formulation;

Heat and light stabilizers: about 1%

Heat is applied to the mixture of polyamides (solid at ambient temperatures), compatibilizer (solid), impact modifier (solid), and plasticizer (liquid) to melt the solid components and for coupling the polyamides with the compatibilizer. Preferably the temperature is raised above the melting points of the resins, such that all or substantially all the polyamide is melted. Nylon 12 has a melting point of 167-184° C. (Vicat Softening Point 120-160° C.) and Nylon 6 a melting point of about 193-255° C., generally about 220° C. (Vicat Softening Point 180-204° C.).

For example, the ingredients for the nylon 6,12 alloy are fed into a twin screw extruder or similar high shear mixing device. The extruder heats the materials to a temperature of about 230-250° C. and mixes the materials. A batch process or continuous feed process may be used. The residence time has some influence on the properties of the material and can be adjusted to optimize the properties desired. The nylon 6,12 alloy is formed in the extruder and ejected as a mixture, which is pelletized and stored until needed for forming a layer of the hose. Alternatively, the molten alloy can be fed directly to an extruder for forming the hose.

The nylon 12 layers 16, 20 (where present) and nylon 6 layers 30, 44 may be either modified or unmodified. If modified, it is anticipated that the material will contain various plasticizers as are readily known in the art. Preferably, the polyamide contains up to 17% by composition weight plasticizer; with amounts between about 1% and about 13% being preferred. Suitable plasticizers include butyl benzene sulfonamide or similar plasticizers, as discussed above. The nylon 12 layers 16, 20 (where present) are preferably formed from a plasticized polyamide, such as those which are commercially available from Huls under the tradename X7293 or Atofina's Rislan AESNO P40 or P401 TL. Alloys of nylon 12 may also be employed. Suitable alloys include nylon 12, which is blended with less than 50% by weight of a compatible polymer, such as a maleic anhydride modified high density polyethylene. As discussed above, the term “nylon 12 layer” is intended to include both 100% nylon 12 as well as comparably performing nylon 12 blends.

The nylon 6 used for layers 30 and 44 preferably has the following characteristics:

Ambient flex modulus: 2800-7000 kg/cm² (40,000-100,000 psi), preferably about 3500 kg/cm² (50,000 psi) (as measured by ASTM Standard D-790).

Elastic modulus @ 110° C. (230° F.): 700-2800 kg/cm² (10,000-40,000 psi), preferably about 1400 kg/cm² (20,000 psi) (as measured by ASTM Standard D-638).

Yield Strength @ 110° C. (230° F.): 70-140 kg/cm² (1000-2000 psi), preferably about 105 kg/cm² (1500 psi) (as measured by ASTM Standard D-638).

Izod Impact Strength (notched) @ −40° C.: 0.7-2.0 (about 38-108 J/m, preferably 1.6 ft-lbs/in (about 86 J/m) (as measured by ASTM Standard D-256).

The nylon 6 layer 30, 44 preferably includes a plasticized nylon 6 polyamide, such as the nylon 6 resin used for the nylon 6,12 alloy layers, and may optionally also include an impact modifier, such as a maleic anhydride modified ethylene/propylene non-conjugated diene elastomer or other impact modifiers or combinations thereof as discussed above. A compatibilizer, such as maleic anhydride modified polyethylene or other compatibilizers or combinations thereof as discussed above, is preferably also present. Since the nylon 6 base resin used may contain a proportion of residual nylon monomer (caprolactam) this may also be present and serve an additional plasticizing function. A preferred nylon 6 formula includes:

Nylon 6 base resin: 50-75%, preferably, about 63%;

Plasticizer: Butyl benzene sulfonamide: 10-16% by weight, preferably, about 14% (e.g., Unitex Uniplex™ 214);

Residual nylon monomer-caprolactam: 5-10% by weight, generally, about 7%;

Maleic anhydride modified ethylene/propylene non-conjugated diene elastomer: 5-15% by weight, preferably, about 10% (e.g., Crompton Royaltuf 498);

Maleic anhydride modified polyethylene: 5-25% by weight, preferably, about 20% (e.g., DuPont Fusabond MN-493D); and Suitable heat and light stabilizers (about 1%).

To form the tubing 10, the innermost layers 20, 46 (where present) and 44 of nylon 12 (where present), nylon 6,12 alloy, and nylon 6 are coextruded first. The melt temperature of the nylon extruder is preferably about 235° C. to about 245° C., more preferably, about 238° C.

The reinforcing layer 45 is then added. To form the reinforcing layer 45, the extruded layers 20, 44 (and optionally 46, where present) are passed through a braider or fiber reinforcing apparatus. The reinforcing material may be braided, knitted, or spirally wrapped wherein one strand of the material is applied with a pitch in one direction and another strand is applied over the first with a pitch in the opposite direction. The braider is preferably a counter rotating fiber reinforcing device. Preferably, the braided layer 45 is applied with six bobbins of fiber applied at from two to five picks per inch, more preferably, three picks per inch.

Once the reinforcement is applied, the outer layers 22, 40, 30 forming the jacket 42 are co-extruded over the inner tubing in the same manner as the first two or three layers 20, 46, 44, at the same temperatures. The formed tubing is then passed through a cooling bath. The resulting extruded product 10 has an outer diameter of about 9.0 to about 20 mm and is ready for use.

Since the inner layer 20, is generally not exposed to the effects of zinc chloride degradation, or is much less likely to suffer zinc chloride degradation than the outer layer 22, it is contemplated that the inner peripheral layer 20 may alternatively be formed from a less expensive polyamide, such as nylon 6, nylon 6-6, or other suitable material, as shown in FIG. 3. In this embodiment, the layer 44 is omitted. The hose of FIG. 3 is otherwise similar to that of FIGS. 1 and 2, although it is also contemplated that an outer layer 22 of the nylon 6,12 alloy may replace the combination of an outer nylon 12 layer 22 and a tie layer 40 of nylon 6,12 alloy shown.

It is also contemplated that the reinforcing layer 45 may be eliminated as shown in FIGS. 4 and 5. FIG. 4, for example, shows a hose 10 in which inner and outer peripheral layers 50, 52, comprising the nylon 6,12 alloy of the present invention, are spaced by an interior layer 54 of a compatible material, such as nylon 6. The layers 50, 52 may be of similar thickness to layers 20 and 22 of FIG. 2 (i.e., from about 0.12-0.36 mm in thickness. Layer 54 may be equivalent in thickness to the combined thicknesses of layers 30 and 44 of FIGS. 1 and 2. (i.e., from about 1.0-1.6 mm in thickness). In an alternative embodiment, layers 50 and 52 may be formed from nylon 12 and intermediate layer 54 may be the nylon 6,12 alloy. In yet another embodiment, layer 50 is eliminated, for example, where zinc chloride resistance of the inner peripheral layer is not of concern. In this latter embodiment, an outer peripheral layer 52 of the nylon 6,12 alloy and an inner peripheral layer 54 of nylon 6 make up the hose.

In FIG. 5, tie layers 60, 62 of the nylon 6,12 alloy, which are analogous to layers 40 and 46 of FIG. 2, space outer and inner peripheral layers 64, 66, respectively, from an interior layer 68. Layers 64,66 are formed from nylon 12 and are analogous to layers 22 and 22 of FIG. 2, while layer 68 is formed from nylon 6, analogous to layer 54 of FIG. 4.

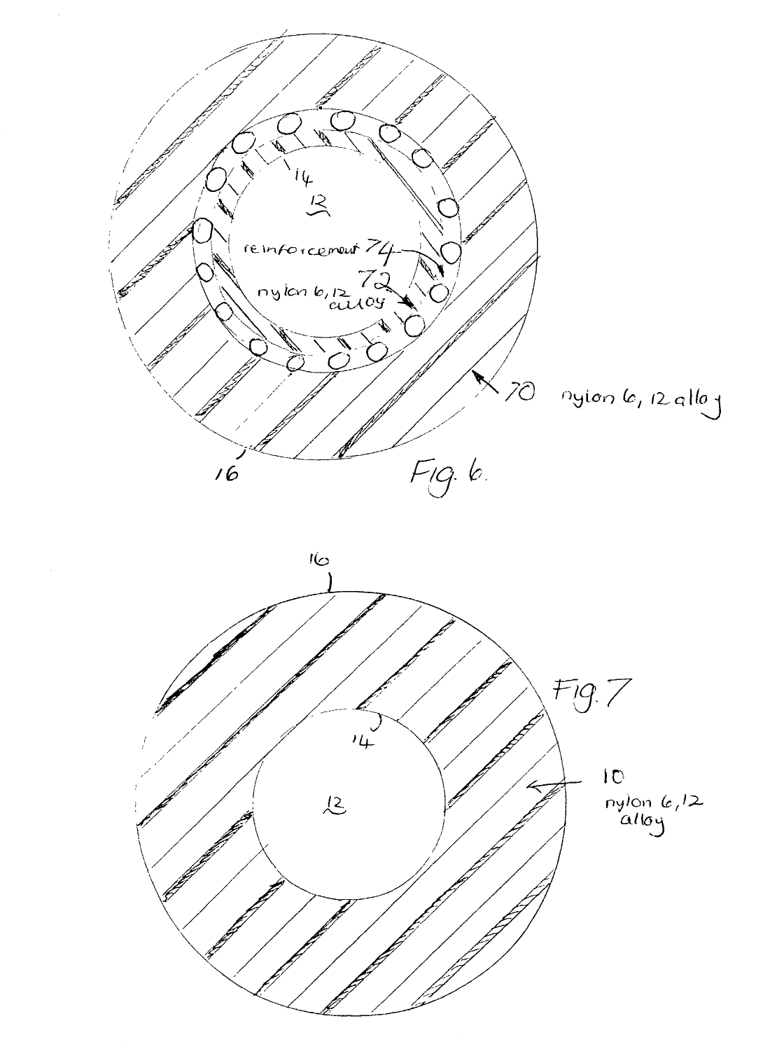

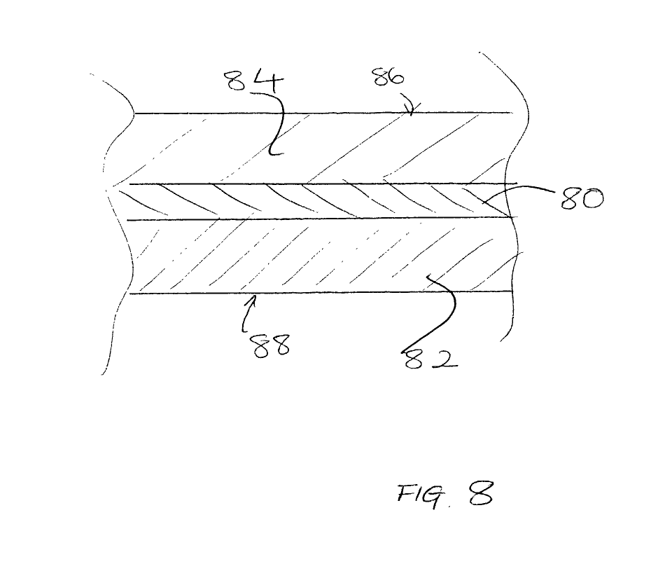

In yet further embodiments, shown in FIGS. 6 and 7 the nylon 6,12 alloy provides all of the polyamide layer(s) in the hose 10. In FIG. 6, an outer peripheral layer 70 of nylon 6,12 alloy is coextruded with an inner peripheral layer 72 of nylon 6,12 alloy and an intermediate reinforcing layer 74. Inner and outer layers 70, 72 may be of the same thickness, or as shown in FIG. 6, one of the layers may be of greater thickness than the other. It is contemplated that the formulation of the alloy for the layers 70, 72 (and in other cases were the alloy serves are peripheral layers) may be the same or different. For example, the outer peripheral layer 70 may have a higher proportion of nylon 12 than the inner peripheral layer 72, to provide enhanced zinc chloride resistance.

As will also be appreciated from the foregoing, in an alternative embodiment, one or other of layers 70 and 72 of FIG. 6 may be replaced with a layer of a compatible material, such as nylon 12 or nylon 6.

FIG. 7 is analogous to FIG. 6, but without the reinforcing layer. The hose 10 is formed entirely from the nylon 6,12 alloy.

It will be appreciated that other combinations of layers may also make up the hose, taking the following into consideration:

The outer surface 16 of the hose is preferably defined by a zinc chloride resistant layer, such as the nylon 6,12 alloy, nylon 6,11 alloy, nylon 11, or nylon 12;

The inner surface 14 of the hose is preferably defined by a zinc chloride resistant layer, such as the nylon 6,12 alloy, nylon 6,11 alloy, nylon 11, or nylon 12, although this is generally less important than for outer surface 16; and

The tie layer preferably comprises polyamides that are present in the two adjacent layers. For example, where a nylon 12 layer is employed, it is spaced from any layer(s) of nylon 6 present by a tie layer which is compatible with both layers, such as a layer of the nylon 6,12 alloy.

While the invention has been described with particular references to hoses, it will be appreciated that other multi-layer structures may also be formed with a layer of the alloy of the present invention, such as a nylon 6, 12 alloy. For example, as shown in FIG. 8, a multi-layer film is shown. The film includes a first layer 80 of the nylon 6, 12 alloy, formulated as described above. A second layer 82 of nylon 6 or similar caprolactam-based polyamide present in the alloy and/or a third layer 84 of nylon 12, or other polyamide present in the alloy, are optionally coextensive with the first layer, and may be formed by a lamination process similar to the coextrusion process described above. While the film is shown as having opposed upper and lower exterior surfaces 86, 88, defined by layers 84 and 82, respectively, it will be appreciated that additional layers may also be present in the structure to suit particular applications. As discussed for the hose, the alloy formulation may also provide one or other of the outer layers of a film.

Without intending to limit the scope of the invention, the following examples describe methods of preparation of various nylon 6,12 alloy formulations and compare the formulations with other polyamide formulations.

### EXAMPLES

### Example 1

Evaluation of the Effect of Nylon 12 Concentrations on Nylon 6,12 Alloys Formed without Additional Plasticizers

Various nylon 6,12 alloy formulations were prepared using different concentrations of nylon 6 and nylon 12 resins. The mixtures were compounded at a sufficient temperature to melt the polyamides and extruded using a twin screw mixer and pelletized. Samples of the formulations were extruded as ribbons, using a Brabender mixer with a Maddox® screw and 1″ die. The screw was rotated at 60 RPM. In the case of Formulation 4, below, a mesh screen (20/70) was fitted between the extruder and the die. The screen serves to remove larger particles and also create a backpressure on the material. The mixture was cooled and tested to determine its suitability as a tie layer.

Testing Procedures were used as follows:

Izod Impact Strength (notched) @ −40° C.: ASTM D-256

Elastic modulus @ 110° C. ASTM D-638

Yield Strength @ 110° C. ASTM D-638

Ambient flex modulus: ASTM D-790

Specific Gravity: ASTM D-792

Table 1 details the results obtained. Formulations 1, 6, and 7 were control experiments. Formulations 1 and 7 used 100% of a commercially available copolymerized nylon 6,12 material, obtained from DuPont or Huls, respectively. Formulation 6 employed 100% of a nylon 6 alloy. The remaining formulations used different proportions of nylon 6 and nylon 12 resins to form the nylon 6,12 alloy.

TABLE 1

| Primary | | Density | Formulation | | | | | | |
|---|---|---|---|---|---|---|---|---|---|
| Material | Tradename | (g/cc) | 1 | 2 | 3 | 4 | 5 | 6 | 7 |
| Nylon 6 alloy | XP-727-45 | 1.052 | | | | | | 100% | |
| Nylon 6 | Ultramid B35 | 1.130 | | 30.0% | 22.5% | 50.0% | 37.5% | | |
| Nylon 12 | Rislan | 1.030 | | 50% | 37.5% | 30.0% | 22.5% | | |
| | AESNO P401 | | | | | | | | |
| | TL | | | | | | | | |
| MAGEPD | Royaltuf 498 | 0.910 | | 10.0% | 20.0% | 10.0% | 20.0% | | |
| (impact | | | | | | | | | |
| modifier) | | | | | | | | | |
| MAGPE | Fusabond | 0.870 | | 10% | 20% | 10% | 20% | | |
| (compatibilizer | MN-493D | | | | | | | | |
| Nylon 6, 12 | Dupont 6/12 | n/k | 100% | | | | | | |
| Copolymer | | | | | | | | | |
| Nylon 6, 12 | Huls Nylon | 1.050 | | | | | | | 100% |
| Copolymer | 6, 12 | | | | | | | | |

| | | | | | | | |
|---|---|---|---|---|---|---|---|
| Totals | 100% | 100% | 100% | 100% | 100% | 100% | 100% |
| Properties of Extruded Material | | | | | | | |
| Specific gravity (ASTM D-792) | 1.061 | 1.011 | 0.976 | 1.029 | 0.986 | 1.046 | 1.052 |
| Elastic modulus at 230° F. (lb/sq in) | 30150 | 26983 | 9050 | 33333 | 12390 | 11900 | 30950 |
| Yield strength at 230° F. (lb/sq in) | 3190 | 1857 | 762 | 2143 | 857 | 1071 | 2619 |
| Flex modulus (lb/sq in) | 126030 | 170277 | 78365 | 215784 | 100183 | 55539 | 136887 |
| Low temperature Izod (ft-lbs/in) | 1.3 | 3.7 | 3 | 2.8 | No | 2.8 | 1.47 |
| | | | | | Break | | |

As can be seen from Table 1, several of the formulations exhibited a good (high) elastic modulus and good (high) yield strength (e.g., Formulations 1 and 4) and others showed good (low) flex modulus (e.g., Example 3). However, in general the combination of high elastic modulus, high yield strength, and low flex modulus suited to a tie layer for high performance hoses was not found together in a single example. Further experiments were carried out to tailor the formulations to such applications, as described in EXAMPLE 2.

### Example 2

Modified formulations were prepared and tested in the same manner as for EXAMPLE 1, as shown in TABLE 2. As can be seen from the results, Formulation 11 (compounded nylon 6, nylon 12 alloy with 37.5 nylon 6 and 32.5% nylon 12) exhibited good overall characteristics (high elastic modulus, and yield strength, low flex modulus) making it suited to use as a tie layer. The presence of a with 37.5 nylon 6 and 32.5% nylon 12) exhibited good overall characteristics (high elastic modulus, and yield strength, low flex modulus) making it suited to use as a tie layer. The presence of a plasticizer (Uniplex 214) in place of a portion of the other additives appears to give the product some advantages as a tie layer.

TABLE 2

| | | Density | Formulation | | | | | | |
|---|---|---|---|---|---|---|---|---|---|
| Material | Tradename | (g/cc) | 8 | 9 | 10 | 11 | 12 | 13 | 14 |
| Nylon 6 | Ultramid B35 | 1.150 | 25.0% | 29.0% | 37.5% | 37.5% | 37.5% | 30.0% | 37.5 |
| Nylon 12 | Rislan | 1.030 | 45.0% | 48.0% | 32.5% | 32.5% | 32.5% | 50% | 22.5 |
| | AESNO P401 | | | | | | | | |
| | TL | | | | | | | | |
| Impact | Royaltuf 498 | 0.910 | 15.0% | 10.0% | 15.0% | 13.0% | 13.0% | 10% | 20.0 |
| Modifier | | | | | | | | | |
| Compatibilizer | Fusabond | 0.870 | 15.0% | 10.0% | 15.0% | 13.0% | 13.0% | 10% | 20.0% |
| | MN-493D | | | | | | | | |
| Plasticizer | Uniplex 214 | 1.150 | | 3.0 | | 4.0 | 4.0 | | |

| | | | | | | | |
|---|---|---|---|---|---|---|---|
| Totals | 100% | 100% | 100% | 100% | 100% | 100% | 100% |
| Properties of Extruded Material | | | | | | | |
| Specific gravity (ASTM D-792) | 0.998 | 1.012 | 1.007 | 1.026 | 1.009 | 1.012 | 0.99 |
| Elastic modulus at 230° F. (lb/sq in) | 8090 | 16660 | 14290 | 17610 | 12860 | 17150 | 7620 |
| Yield strength at 230° F. (lb/sq in) | 619 | 1238 | 1095 | 1143 | 857 | 1381 | 667 |
| Flex modulus (lb/sq in) | 33620 | 58401 | 77460 | 55249 | 48676 | 64910 | 41522 |
| Low temperature Izod (ft-lbs/in) | *12.4 | *3.65 | 3.50* | NB | 2.44* | NB | NB |

** Denotes some values that were “No Break” Values
NB- all values were No Break

### Example 3

### Formulation of a Translucent Compounded Nylon 6, Nylon 12 Alloy

A tie layer formulation (Formulation 16) was prepared and tested as described for the products of EXAMPLE 1. In this formulation, the material was rendered translucent by omission of the impact modifier. Results are shown in TABLE 3, where the results are compared with those for a 100% nylon 12 resin material. The screw speed was slightly higher than for previous experiments, 70 RPM for Formulation 16, and 75 RPM for Formulation 17.

TABLE 3

| Primary | | Density | Formulation | |
|---|---|---|---|---|
| Material | Tradename | (g/cc) | 16 | 17 |
| Nylon 6 | Ultramid B35 | 1.130 | 39.5 | |
| Nylon 12 | Rislan AESNO P401 TL | 1.030 | 33.5 | 100% |
| Plasticizer | Uniplex 214 | 1.150 | 10.0 | |
| MAGPE | Fusabond MN-493D | 0.870 | 17.0 | |
| (compatibilizer) | | | | |
| Totals | 100% | 100% | | |

| | | |
|---|---|---|
| Properties of Extruded Material | | |
| Specific gravity (ASTM D-792) | 1.043 | 1.019 |
| Elastic modulus at 110° C. (lb/sq in) | 1.5720 | 20950 |
| Yield strength at 110° C. (lb/sq in) | 1429 | 1524 |
| Flex modulus (lb/sq in) | 71719 | 69630 |
| Low temperature Izod (ft-lbs/in) | 3.62 | 0.92 |

The invention has been described with reference to the preferred embodiment. Obviously, modifications and alterations will occur to others upon reading and understanding the preceding detailed description. It is intended that the invention be construed as including all such modifications and alterations insofar as they come within the scope of the appended claims or the equivalents thereof.

Having thus described the preferred embodiments, the invention is now claimed to be:

1. A hose suitable for use in pressurized fluid systems comprising:
a first layer which includes an alloy of a first polyamide which is derived from caprolactam, and a second polyamide derived from at least one of undecanolactam and dodecanolactam; and
at least one of a second layer and a third layer:
the second layer, where present, being bonded directly to the first layer, the second layer including a third polyamide which is derived from caprolactam, and
the third layer, where present, being bonded directly to the first layer, the third layer including a fourth polyamide derived from the at least one of undecanolactam and dodecanolactam.

2. The hose of claim 1, wherein the first layer is closer to a peripheral surface of the hose than the second layer.

3. The hose of claim 2, wherein the first layer defines the peripheral surface of the hose for providing protection to the second layer against zinc chloride degradation.

4. The hose of claim 3, wherein the peripheral surface of the hose is an innermost surface of the hose.

5. The hose of claim 3, wherein the first layer has a thickness of about 0.25 mm.

6. The hose of claim 1, wherein the first layer acts as a tie layer between the second layer and the third layer.

7. The hose of claim 6, wherein the third layer defines a peripheral surface of the hose.

8. The hose of claim 6, wherein the third layer defines an outermost peripheral surface of the hose.

9. The hose of claim 6, wherein the first layer has a thickness of about 0.06-0.13 mm.

10. The hose of claim 1, further including a fourth layer including a reinforcing material, the reinforcing layer being spaced radially further from a peripheral surface of the hose than the first layer.

11. The hose of claim 1, wherein the first layer includes a compatibilizer for rendering the first layer compatible with the at least one of the second and third layers such that the first layer bonds to the at least one of the second and third layers during coextrusion, the compatibilizer including a polyolefin modified with an α,β-unsaturated carboxylic acid, an alicyclic carboxylic acid, or derivative thereof.

12. The hose of claim 11, wherein the compatibilizer includes a maleic anhydride grafted polyolefin.

13. The hose of claim 12, wherein the compatibilizer includes a maleic anhydride grafted polyethylene.

14. The hose of claim 1, wherein the first layer further includes an impact modifier.

15. The hose of claim 14, wherein the impact modifier includes a maleic anhydride-grafted polyolefin rubber.

16. The hose of claim 15, wherein the impact modifier includes a maleic anhydride-grafted ethylene/propylene/diene elastomer.

17. The hose of claim 1, wherein the first layer further includes a plasticizer.

18. The hose of claim 17, wherein plasticizer includes an alkyl aryl sulfonamide.

19. The hose of claim 1, wherein the first polyamide is selected from the group consisting of nylon 6; nylon 6,6; and combinations thereof.

20. The hose of claim 19, wherein the first polyamide is nylon 6.

21. The hose of claim 1, wherein the second polyamide is selected from the group consisting of nylon 11, nylon 12, and combinations thereof.

22. The hose of claim 1, wherein the first layer comprises:
30-40% of a nylon 6 base resin;
20-35% of a nylon 12 base resin;
0-20% of a plasticizer;
0-10% of residual nylon monomer;
5-25% of a compatibilizer; and
0-20% of an impact modifier.

23. The hose of claim 22, wherein the first layer comprises:
30-40% of a nylon 6 resin;
20-35% of a nylon 12 resin;
6-10% of a plasticizer other than caprolactam;
0-2% of caprolactam;
10-20% of a maleic anhydride grafted polyalkylene; and
10-15% of a maleic anhydride grafted polyalkylene/diene elastomer.

24. The hose of claim 22, wherein the first layer is translucent and comprises:
30-40% of a nylon 6 resin;
20-35% of a nylon 12 resin;
6-10% of a plasticizer other than caprolactam;
0-2% of caprolactam; and
10-25% of a maleic anhydride grafted polyethylene.

25. A formulation suitable for forming a layer of a hose comprising:
30-40% of a polyamide derived from caprolactam;
20-35% of a polyamide selected from nylon 12, nylon 11, and combinations thereof;
5-20% of a plasticizer other than caprolactam;
0-10% of caprolactam;
5-25% of a maleic anhydride grafted polyalkylene; and
0-20% of an impact modifier other than the maleic anhydride grafted polyalkylene.

26. A method of forming a multi-layer structure comprising:
coextruding a first layer and at least one of a second layer and a third layer the first layer bonding to the at least one of the second layer and the third layer as the layers are coextruded;
the first layer including an alloy of a first polyamide and a second polyamide, the alloy formed by mixing the first polyamide with the second polyamide, the first polyamide being derived from caprolactam, the second polyamide being selected from the group consisting of nylon 11, nylon 12, and combinations thereof;
the second layer, where present, including the first polyamide; and
the third layer, where present, including the second polyamide.

27. A multi-layer structure comprising:
a first layer which includes a first polyamide selected from the group consisting of nylon 12, nylon 11, and combinations thereof;
a second layer adjacent to the first layer which includes a mixture of a nylon 6 polymer and the first polyamide; and
optionally, a third layer which includes a mixture of a nylon 6 polymer and a third polymer selected from the group consisting of nylon 12, nylon 11, and combinations thereof which is spaced from the second layer by at least a fourth layer, the fourth layer including nylon 6.

28. A hose comprising:
an inner peripheral surface and an outer peripheral surface, the outer peripheral surface being radially outwardly spaced from the inner peripheral surface; and
a layer which defines at least one of the inner and outer peripheral surfaces, the layer comprising a generally homogeneous mixture of a nylon 6 polymer and a nylon 12 polymer, the nylon 6 polymer and nylon 12 polymer being held together by maleic anhydride residues of a maleic anhydride modified polymer.

29. The hose of claim 28 wherein all polyamide layers of the hose comprise the generally homogeneous mixture of the nylon 6 polymer and the nylon 12 polymer.
